(19) United States
(12) Patent Application Publication
(10) Pub. No.: US 2016/0189527 A1
(43) Pub. Date: Jun. 30, 2016

(54) Intelligent Object-Based Alarm System

(71) Applicant: Google Inc., Mountain View, CA (US)

(72) Inventors: Kevin Charles Peterson, San Francisco, CA (US); Anthony Michael Fadell, Woodside, CA (US)

(21) Appl. No.: 14/585,224

(22) Filed: Dec. 30, 2014

(51) Int. Cl. G08B 25/00; G08B 31/00

(52) U.S. Cl. CPC G08B 25/008; G08B 31/00

(57) ABSTRACT

A second security system, which may exist inside the perimeter of a first security system, may utilize one or more sensors to observe an object. The first security system may have a “home” mode and an “away” mode. In the event the first security system is in the home mode, the second security system may be in an away mode for the object. If the first security system changes to an away mode, the second security system may change to a home mode for the object.

### BACKGROUND

Certain home security systems tend to have a binary operation. One mode may be an “away” mode when the occupants are away, in which the entry points into a home may be observed for intrusion by an unwanted party. The other mode may be a “home” mode when the occupants are home. The mode can affect the actions taken by the security system in response to sensed activities in the home. For example, in home mode, the sensed opening of an exterior door may result in no action being taken by the security system. In the away mode, the sensed opening of the same door may be construed as an intrusion detection and may trigger a notice to law enforcement. There can also be an intermediate mode between stay and away. For example, there can be a “night” mode for when occupants are sleeping in the home. This mode can, for example, refrain from triggering an alert to the police based on sensed movement in the bedroom and hallways, but send such an alert when an exterior door is opened. The system can transition between modes when a user enters a security code into an entryway security system. Such modes can apply to the security system for the whole home.

### BRIEF SUMMARY

According to an implementation of the disclosed subject matter, a system is provided that includes a first security system that is associated with a premises and having a first mode and a second mode. The first mode may define a first response to an event and the second mode may define a second response to the event that differs from the first response. The system may include a second security system within the premises that has a third mode and a fourth mode of operation. The second security system may operate in one of the third mode or the fourth mode based upon a mode in which the first security system is operating.

In an implementation, a processor may determine that a first security system associated with a premises is in a first mode. The first mode may define a first response to an event and the second mode may define a second response to the event that differs from the first response. A second security system within the premises may be determined to be in a third mode. The second security system may operate in one of the third mode or a fourth mode based at least in part upon a mode in which the first security system is operating. The first security system may be placed into the second mode based on an indication received by the processor. The second security system may be placed in the fourth mode based on the first security system being in the second mode.

In an implementation, a system according to the presently disclosed subject matter may include a means for determining, by a processor associated with a first security system, that the first security system is in a first mode. The first security system may be associated with a premises. The system may include a means for determining that a second security system is in a third mode. The second security system may be within the premises of the first security system. The system may include a means for transitioning the second security system from the third mode to a fourth mode based on the first security system being in the second mode.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 is an example system in which a first security system may have a security perimeter, a first mode, and a second mode as disclosed herein.

FIG. 2 is an example of the home security system or smart home system in which an object is placed in locker or safe as disclosed herein.

FIG. 3 is an example process for the interaction between the first security system and the second security system.

FIG. 4 shows an example hardware configuration of a sensor according to an implementation disclosed herein.

FIG. 5 is an example process for the second security system that is at a higher level of alert irrespective of the first security system's mode as disclosed herein.

FIG. 6 is an example configuration of the first security system and the second security system in the event an intrusion is detected by the first security system.

FIG. 7 is an example process for transitioning the second security system from a third mode to a fourth mode in the event a first security system is transitioned from a first mode to a second mode of operation as disclosed herein.

FIG. 8A shows an example sensor as disclosed herein.

FIG. 8B shows an example of a sensor network as disclosed herein.

FIG. 8C shows an example configuration of sensors, one or more controllers, and a remote system as disclosed herein.

FIG. 9A shows a schematic representation of an example of a door that opens by a hinge mechanism as disclosed herein.

FIG. 9B shows a compass in two different positions that are illustrated in FIG. 8A, according to implementations disclosed herein.

FIG. 10A shows a computer according to an implementation of the disclosed subject matter.

FIG. 10B shows a network configuration according to an implementation of the disclosed subject matter.

### DETAILED DESCRIPTION

The disclosed implementations provide for heterogeneous security zones that can exist within a single premise, each having a different mode at a given time. A change detected in one security zone or in the mode of the one security zone may automatically change the mode of the other security zone or the zones may be independent of each other.

For example, a first security system may be a home-wide security system and be in a home mode as described above. At the same time, a second security system in an away mode may be associated with a given area or object within the home, such as a room, a safe, a gun locker, etc. When the second security system detects that the first security system has transitioned from home mode to away mode, the second security system may transition from away mode to home mode. This may occur because the security provided by the first security system in away mode combined with the security provided by the second security system in stay mode may be sufficient to protect the object that is also protected by the second security system.

The first and second security systems may each be controlled by the same controller, which can associate a first set of sensors with the first security system and a second set of sensors with the second security system. There may be at least some overlap between the first and second sets of sensors. The controller may implement rules for changing the mode of one security system based at least partly on inputs from sensors associated with the other security system, and/or upon changes in mode in the other security system. Each security system may analyze the data generated by the sensors for specific events. For example, the first security system may observe motion in a room to determine whether the lights in the room should be turned on. The second security system may analyze the same motion data to determine if an authorized user is near a particular area of the room (e.g., an area of the room that includes a safe). In some configurations, the same processor, such as that belonging to the controller and/or remote system, may perform the analysis of the sensor data.

In an implementation, a home-wide security system may be placed in a home mode. A second security system may receive input from a sensor package containing one or more sensors that can be affixed to, be proximate to, or otherwise monitor a valuable object within the home. For example, an accelerometer and a humidity sensor may be attached to a perishable object (such as an expensive case of wine) in the basement of the home. While the home-wide security system is in home mode, the perishable object security system may be in an away mode. This can be appropriate when not all of the occupants of a home (e.g., guests) are fully trusted by a user of the first and second security systems, such as an occupant of the home. For example, when the user is hosting a large party, the user may wish to maintain a heightened security status on one or more areas or objects within the same home, while relaxing the security status of the rest of the home. The disclosed subject matter can advantageously allow the user to maintain various levels of security over different areas and objects at the same time. This may be done in a nested fashion. That is, a security zone may be fully or partly contained within another security zone, which may be contained within yet another security zone, and so on. Thus, if the second security system detects that the valuable object such as the case of wine has been moved or opened, an alert message can be sent to the user's smartphone, for example, even though the home-wide security system is in the home mode. When the guests leave and the home-wide security system is placed into a heightened security mode (such as a stay mode for the night), the second security system can be placed into a home mode and not alert the user if the bottle is moved. However, the second security system can alert the user anytime if it detects a hazard to the valuable object, such as dangerously low humidity levels that could adversely affect the quality of the wine.

The disclosed implementations may operate in conjunction with a smart home and/or home security system as described below. The second security system may be associated with an object or area and may operate independently with respect to the different modes of operation of one or more other security systems, such as a home-wide security system.

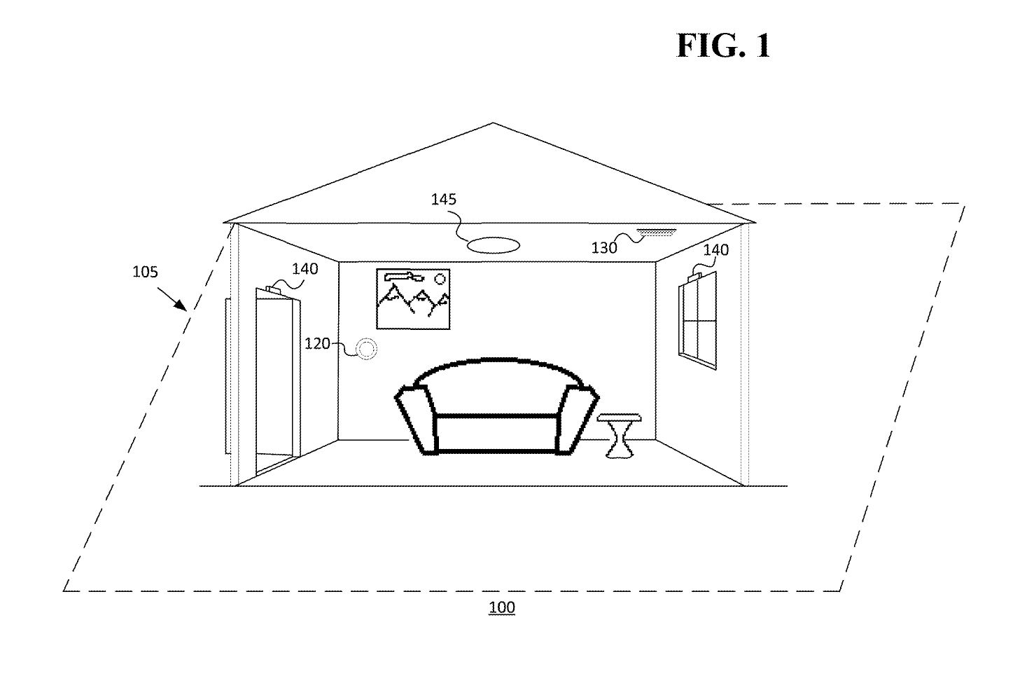

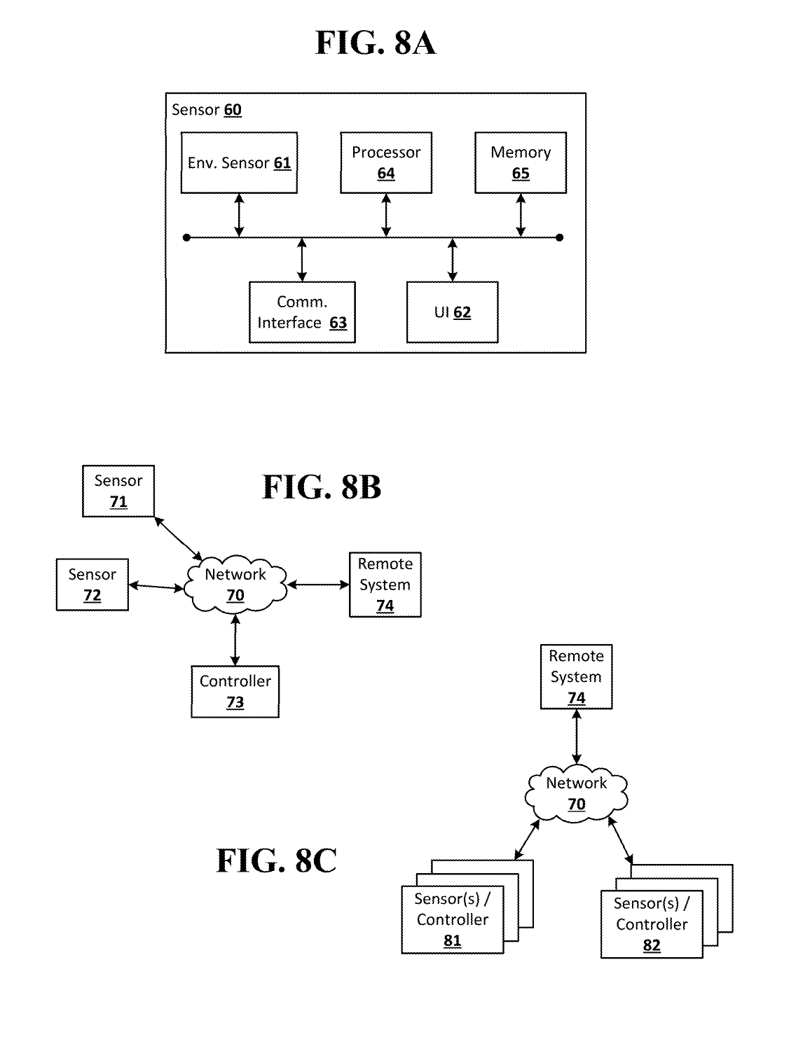

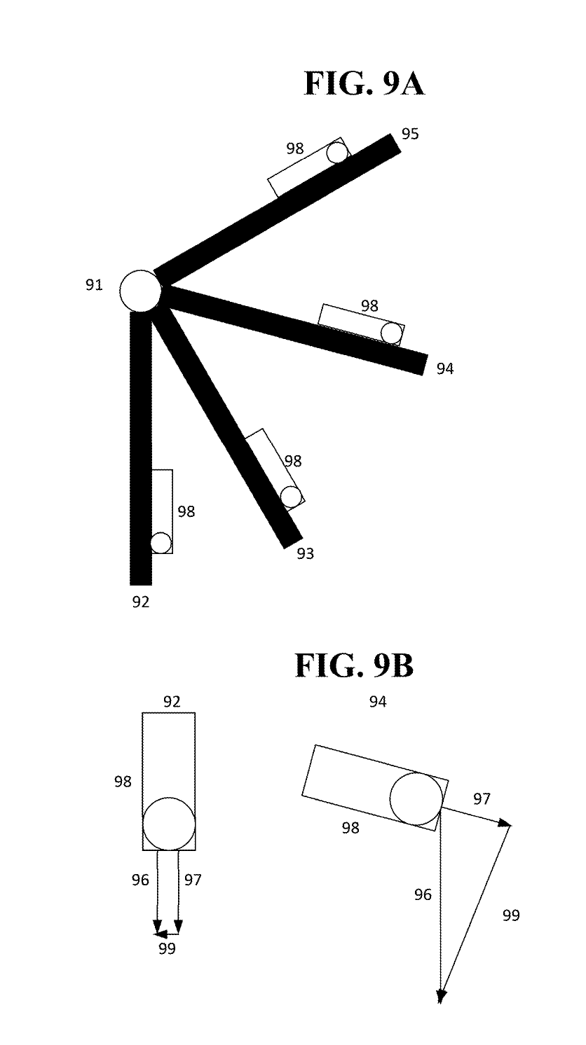

FIG. 1 is an example system in which a first security system may have a security perimeter 105 that defines the premises of the home, a first mode, and a second mode. The first security system may be a component of a smart home system, which is described in detail below with respect to FIGS. 8A-9B. The example smart home or home security system 100 in FIG. 1 may obtain data generated by sensors within the perimeter 105. Smart devices within the system 100 may include one or more intelligent, multi-sensing, network-connected thermostats 120, one or more intelligent, multi-sensing, network-connected hazard detection units 130 (e.g., a smoke detector, carbon monoxide detector), one or more intelligent, multi-sensing, network-connected entry detection units 140, one or more light controllers or sensors 145, and other sensors not depicted. The system 100 may be implemented as an evolving ecosystem of interconnected devices (e.g., nodes 120, 130, 140, and 145) including, for example, passive detector devices and smart sensing devices, each of varying capabilities. The interconnecting nodes 120, 130, 140, and 145 may be components of a mesh network (e.g., Thread). The smart home system 100 may utilize a controller and/or a remote system as described below. These may coordinate decision making across the present system 100 or across a designated portion thereof and the second security system that may be specific to a particular area and/or object within the perimeter 105 of the first security system 100.

The first security system may encompass a number of sensors deployed around the home and/or exterior of the home (e.g., within the perimeter shown in FIG. 1 and including outdoor sensors). For example, the first security system may include window, door, and garage door sensors, a motion detector and exterior lights such as floodlights. In the event of a detected intrusion, the lights may illuminate and/or the system may emit an audible alarm. The first home security system may include one or more interior sensors (e.g., a motion sensor, a smoke alarm, and HVAC sensors) and/or it may be configured to illuminate interior lights according to a pre-set program. The controller for the home security system may communicate with one or more client devices such as a smartphone, personal computer, smart watch, tablet, etc. that may be beyond the perimeter of the system. For example, with a user's permission, a GPS signal from a user's smartwatch may be received by the controller to ascertain the user's present location and determine when to expect the user to return to the home.

The home security system may have a variety of modes, including a home mode and an away mode, which can define a spectrum of alert levels. In the away mode, the system may employ the full gamut of sensors available to the security system and all of its capability with regard to processing the data detected by the sensors and/or executing actions based thereon in an effort to deter unwanted intrusion into the home (or its premises) and detect abnormalities (e.g., a temperature abnormality). For example, in the away mode, the home security system may utilize motion sensors and/or microphones in and around the home, open/close sensors on the entry points into the home, light sensors, etc. to monitor the home for abnormalities with respect to intrusion, motion, sound, temperature, electrical usage, HVAC, light, air quality (e.g., carbon monoxide, smoke, and/or volatile organic compounds). When in the away mode, the home security system may utilize lights, speakers, and/or a controller (describe below) and/or a remote system to attempt to thwart an abnormality detected (e.g., a fire) with the home and/or an intrusion into the home. The home security system may dispatch a notice to an appropriate party (e.g., an authorized occupant of the home, a fire department, a law enforcement agency, etc.).

As stated above, the data generated by the sensors may be analyzed for specific events depending on the mode in which the security system is operating. In the home mode, motion sensor data may be analyzed for movement to activate lights while in the away mode, the motion sensor data may be analyzed to identify a potential intrusion into the home. The home security system may control smart devices associated with the home in unique ways depending on the mode the security system is operating. For example, a home may contain smart lights and smart outlets. The smart lights and outlets may refer to devices that can be controlled based on a learned behavior and/or in response to specific conditions being met. In contrast, an ordinary light operates in response to a binary or dimmer switch actuated by a user and an outlet may be constantly active. In the home mode, smart lights and smart outlets may be activated depending on the presence of particular users in an area. In the away mode, however, the lights and outlets may be deactivated.

In a home mode, the sensors may be used by the home security system to detect only abnormalities associated with the home such as a fire or an unhealthy level of carbon monoxide. For example, an unauthorized occupant could enter the home via a window without triggering an alarm. An away mode may be considered at a higher level of alert than the stay mode. Generally, a home security system may be considered in an away mode if it monitors entry points for unauthorized occupant entry. A person of ordinary skill in the art will recognize that there is a spectrum of different modes between the home and away modes described above. For example, the smart home may have a vacation mode in addition to the home and away modes. In the vacation mode, the system may alert a different party from the authorized occupant in the event it detects an abnormality with the home. Further, it may control the lights in the home and make them mimic a pattern of usage that mimics an authorized occupant's usage during the vacation period. Likewise, the smart home may have a night mode in which the sensor inputs from exterior doors and windows may trigger notices, but movement within the home without indications of changes in exterior doors and windows may not.

In some configuration, the smart home may utilize a modified home mode based on the time of day. For example, if the home security system was placed into a home mode, it may transition to a nighttime stay mode between 11:00 PM and 6:00 AM. In the nighttime mode, it may activate security measures on the exterior of the home, such as motion-triggered lights. Other sensors on the interior of the home may operate as they normally would in a home mode. The system may automatically transition from a home mode to a nighttime stay mode based on the time of day and/or the amount of movement it detects on the interior of the home. For example, the amount of movement in the interior of the home may diminish in specific areas of the home as the occupants go to sleep.

In an implementation, the second security system may change its security mode in response to a combination of sensor inputs from sensors associated with the first security system, the second security system and/or other security systems and/or from determinations made by other security systems. For example, the second security system mode may change from home to away upon receiving an indication from an internal door sensor that a door proximate to an area monitored by the second system is being opened from the outside, a determination from another security system that an exterior door on the same premises has recently been opened from the outside by a possible intruder and a determination from yet another security system that all of the registered occupants are located at least 1000 yards from the premises. Likewise, the second security system may change its mode based on the occurrence of an event, combined with other inputs.

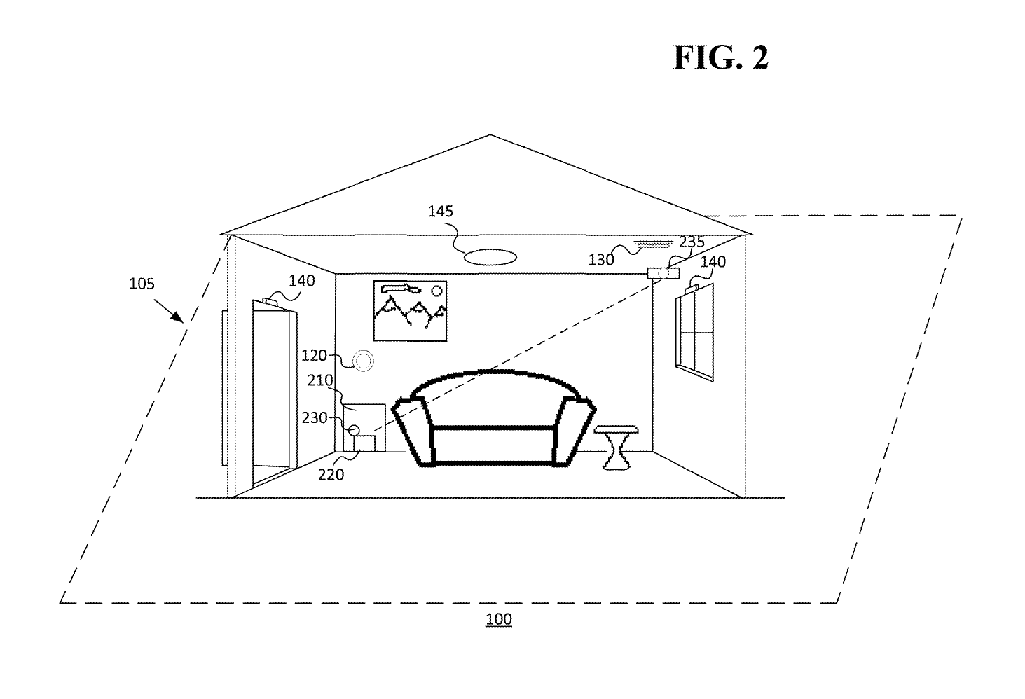

FIG. 2 is an example of the home security system or smart home system 100 in which an object 220 is placed in locker or safe 210. The object 220 may be associated with a variety of sensors 230 and remote sensors 235. An association of sensors with an object may refer to direct and/or direct methods. As an example, sensors may be physically attached to the object 220 in the locker 210 itself and/or indirectly on the locker 210. In FIG. 2, the sensors 230 on the object 220 may be part of a sensor package. In the example shown, the sensors 230 may include an accelerometer and a light sensor. The accelerometer may indicate to the home security system if the object is moved and the light sensor may indicate that the object is being exposed to light (e.g., by the door to the locker being opened). The sensors 230 may be affixed to the object by any number of techniques such as string, a sticker, a tag, a fastening mechanism (e.g., a screw, a bolt, and a nut), etc. A remote sensor 235 may be associated with the object as well. For example, the remote sensor 235 may be a camera that can determine if the door to the locker 210 has been opened or if another user is proximal to the locker 210. The data generated by the remote sensor 235 may be analyzed by the controller and/or remote system for the home security system for multiple events (e.g., occupancy of the room and/or opening of the locker 210) simultaneously. The sensors 230 and remote sensors 235 associated with the object may be considered a second security system that exists within the premises that is observed by the first security system.

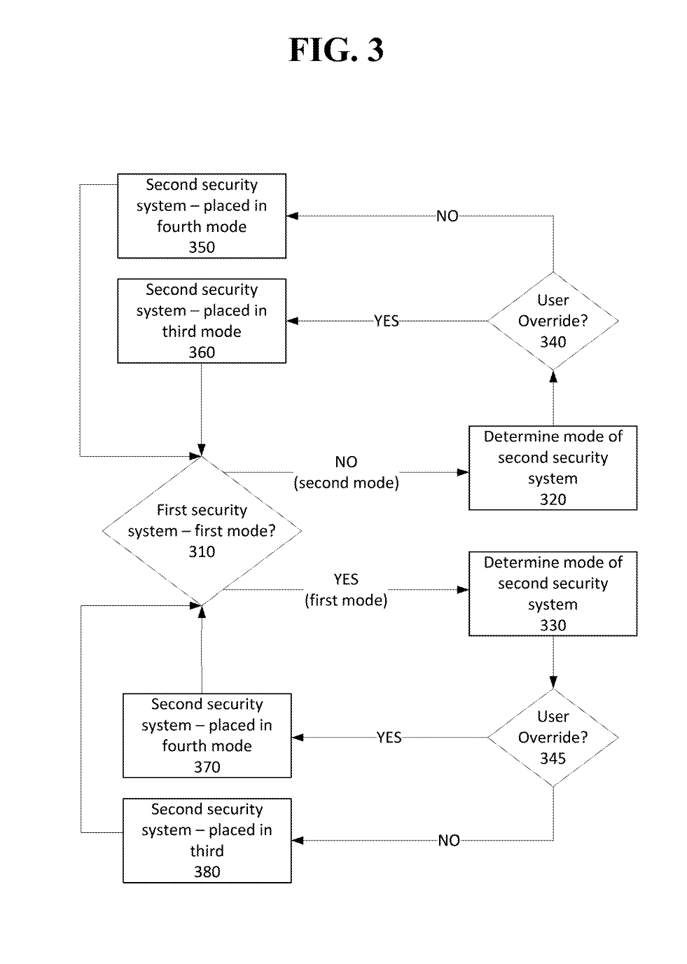

The second security system may have a third mode and fourth mode of operation. As above with respect to the home and away modes of the first security system, the second security system may have a similar spectrum of security modes and/or abnormality detection based on a user's personal preferences and/or the status of the first security system. FIG. 3 is an example process for the interaction between the first security system and the second security system. The process shown in FIG. 3 may be carried out by a processor connected to the smart home controller and/or remote system as described below. In some configurations, the second security system may have a distinct processor that performs some of the processes shown. For example, the second system's processor may receive an indication of the first system's mode and/or user preferences at 320, 330, 340, 345.

At 310, the controller and/or remote system of the home security system (i.e., the first security system) may be determined to be in the first mode or the second mode. The first mode of operation may refer to a home mode and the second mode may refer to an away mode. As described above, the home mode may analyze sensor data for a particular set of features that is distinct from the analysis performed when the home is in the away mode. As a specific example, in the home mode, microphones may listen for voice commands, interior lights may illuminate in response to detected motion, and smart outlets may be activated. In contrast, in the away mode, the interior lights and outlets may be deactivated and the microphones may listen for sounds of intrusion or disturbance to the premises (e.g., the system may ignore voice commands).

If the first security system is in the second mode (e.g., away mode) then the controller and/or remote system may determine at 320 the mode of the second security system. If the first security system is in the first mode (e.g., home mode), then it will determine the mode of the second security system at 330. The complement of sensors associated with the second security system may overlap with the first security system or be unique to the second security system such as the example provided in FIG. 2. The analysis performed on the sensor data may differ depending on the mode of the first security system and/or second security system. For example, motion camera data in the first security system may be used to determine when a light should be activated in a room. The same camera may also monitor the opening of a locker (e.g., as part of the second security system). Thus, a second security system may refer to sensors whose data are utilized to observe the object whereas a first security system may refer to sensors whose data are utilized to observe the home (e.g., entry points, HVAC, lights, exterior functions). The second security system may utilize the same controller and/or remote system as the first security system.

The first security system can be distinguished from the second security system because of the behavior of the system in response to an event, the analysis performed on the obtained sensor data, and/or the use of one or more sensors unique to one particular security system. For example, an accelerometer for a wine bottle may be part of a second security system for the bottle and not part of a broader home security system (i.e., the first security system). Thus, the second security system is specific to an object or area within the premises of the home.

The second security system may have a third mode and a fourth mode. The third mode may correspond to an away mode for the object and the fourth mode may correspond to a home state for the object. An away mode for the object may define a first response to an event and the home mode for the object may define a second response to the event. The modes may differ in the sensors utilized, the analysis of the sensor data, and the response. The away mode for the object may be associated with a more secure state than the home mode for the object. For example, in the home mode for the object, the system may observe the object using only a room motion sensor. In the event motion is detected in the room in which the object is located, the object may transition to an away state and the observed behavior of sensors associated with the object in this particular mode may be analyzed. In the away mode for the object, more sensors associated with the object may be activated and proximity of a person near the object may be more closely scrutinized. Generally, when the home security system is in an away mode, the object's security system may be in a home mode. In the away mode, the home security system observes the household for intrusion and/or abnormalities. Therefore, it may be redundant to have the object's security system observe the object for the same types of intrusion and/or abnormalities. Rather, the object's security system, by operating in a home mode may conserve power consumption by a sensor package affixed to the object because fewer sensors may be operational in the home mode. Similarly, the home mode for the object may improve the efficiency of the controller or other processor to analyze and detect an intrusion and/or abnormality. The controller may analyze sensor data generated by a multitude of sensors. In the home mode for the object, not all of the sensors may generate data and/or not all possible analyses for abnormalities associated with the object may be performed.

As an example, the second security system may utilize an accelerometer, a motion camera, a locker door sensor, and a light sensor. In the third mode, the second security system may utilize the sensors to observe the object or the area in which the object is contained (e.g., the locker or immediately surrounding area). In contrast, in the fourth mode (e.g., home mode for the object), the second security system may not utilize the motion camera sensor and may only monitor the accelerometer and/or locker door sensor.

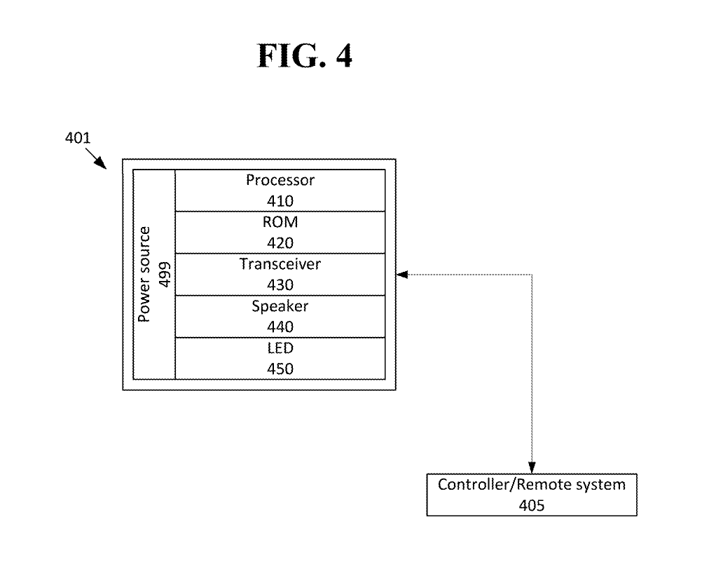

The second security system may be based on a sensor package that is associated with an object, an area such as a particular room of a premises, and/or sensors that are directed toward observation of the object's environment or enclosure. For example, FIG. 4 shows an example hardware configuration of a sensor 401. The sensor 401 may be an accelerometer that measures movement in the x-, y-, and z-axis. In some configurations, the sensor 401 may be paired with a controller and/or remote system 405 that controls a first security system. The sensor may include a processor 410, read only memory 420, a radio transceiver 430, a speaker 440, a LED 450, etc. A power source 499, such as a battery, may provide power to the sensor 401. The memory 420 may store instructions related to the basic operation of the accelerometer's function. The radio transceiver 430 may transmit data generated by the sensor 401 to the controller and/or the remote system 405. In some instances, based on the data generated by the accelerometer and/or other sensors from the first security system or second security system, the sensor 401 may receive instructions from the controller and/or remote system 405. For example, based on a detected movement of the object to which the sensor is associated, the sensor 401 may be instructed to emit a series of beeps from a speaker 440 and flash the LED 450 according to a predetermined pattern. In some configurations, the memory may contain instructions to beep in response to a threshold level of movement and may notify the controller and/or remote system 405 only if the movement exceeds a specified threshold level of movement.

The controller and/or remote system 405 may contain a configuration interface that may allow an occupant to associate one or more sensors of the first security system with the second security system represented by the sensor 401. The sensor may connect to a Wi-Fi network or mesh network (e.g., Thread), for example, on which other sensors and the controller 401 are present. The user interface of the controller and/or remote system 405 may enable a search for other sensors on the same network. A user may be asked to provide a device ID of the sensor and/or otherwise authorize the addition of the new sensor 401. Upon being associated with the controller and/or remote system 405, the system an occupant may associate other sensors that are part of the first security system with the object to form the second security system. For example, a user interface may be provided that displays the field of view of motion capture cameras in each room in the house. A user may draw a box around the object's environment (e.g., a locker) in a field of view of a motion capture camera in the room in which the object is located to indicate that if a person is detected in proximity to the object's environment that the occupant would like a customized action based on the second security system's configuration. The motion camera may be a component of the second security system with respect to the area configured to be associated with the object, represented by the drawn box. Other sensors may be likewise associated with the object. For example, a user may configure a door sensor on a locker in which the object is stored to be a part of the second security system.

Returning to FIG. 3, at 340 and 345, the controller and/or remote system may determine if there is a user preference that specifies an override for the second security system. For example, at 340, the first security system may be in the second mode (e.g., an away mode). The second security system in this configuration may be in a fourth mode (e.g., a home mode). As a default, the system may be configured to place the second security system into a fourth mode at 350 if the first security system is in the second mode. In the absence of user preferences at 340, the second security system may be placed in the fourth mode of operation at 350. If a user override is determined to be present at 340, the second security system may be placed into a third mode (e.g., an away mode) at 360. There may be time delay before the system performs the check at 310 after making the determination at 320 or the determination at 320 may be made again only in the event there is a disturbance (e.g., intrusion or abnormality) to the first security system or the second security system.

Similarly, at 330, the first security system may be determined to be a first mode of operation (e.g., a home mode). At 330, the status of the second security system may be determined at 330. As above, the system may determine if there are any overrides specified at 345. If there are no overrides and/or as a default, the second security system may be placed in a third mode of operation (e.g., an away mode) at 380. If a user override is specified at 345, then the second security system may be placed into a fourth mode of operation (e.g., a home mode) at 370. As above, there may be time delay before the system performs the check at 310 after making the determination at 330 or the determination at 330 may be made again only in the event there is a disturbance (e.g., intrusion or abnormality) to the first security system or the second security system.

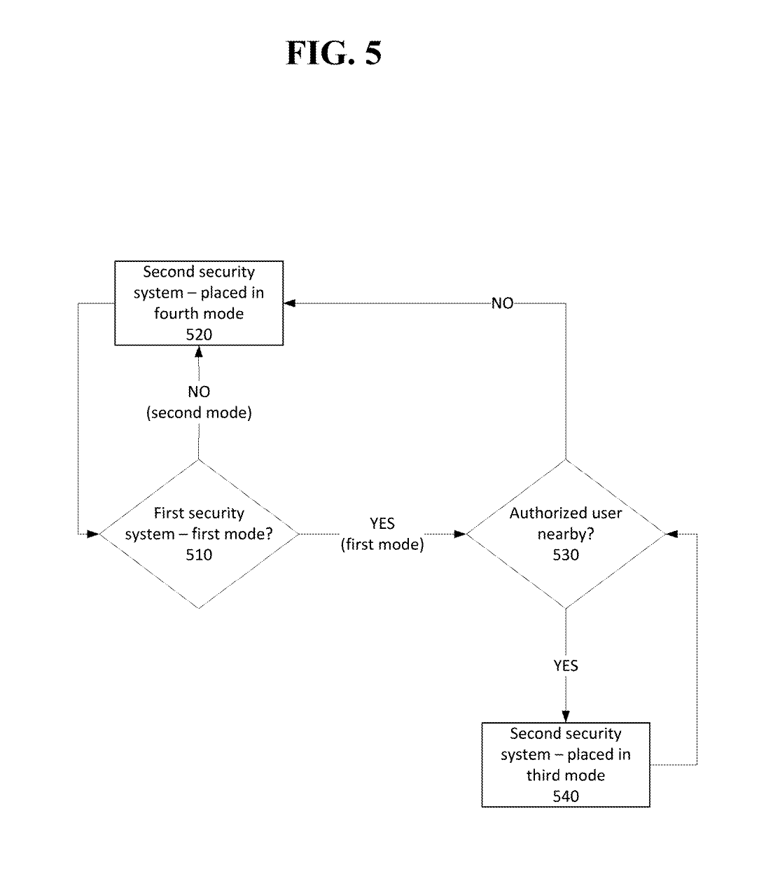

In some configurations, the second security system may transition to an away mode in response to an intrusion and/or abnormality detected by the first security system. The controller may be configured to determine an authorized occupant state as shown in FIG. 5. At 510, the mode of the first security system may be determined. If the first security system is in a second mode of operation (e.g., an away mode) at 510, then the second security system may be configured to be in a fourth mode of operation (e.g., a home mode) at 520. If, however, the first security system is in a first mode of operation (e.g., a home mode), then the controller and/or remote system may determine at 530 an authorized user's proximity to the object. In the event that the authorized user is determined to be proximal to the object (e.g., within a threshold distance from a locker containing the object) or in the same room as the object, the sensors of the second security system may be placed into a third mode of operation (e.g., an away mode) at 540.

As a specific example of this implementation, a user may have a gun (e.g., an object) that is stored in gun locker (e.g., safe or other such enclosure). The gun may have an accelerometer sensor associated with it similar to that described in FIG. 4 and the locker may have a door sensor to determine if the handle is turned and/or if the door is opened. While the user is at home, the gun sensor and locker may be deactivated only if the user is less than one meter from the locker as determined by one or more cameras whose field of view encompass the locker and/or a GPS signal from the user's GPS-enabled device. The authorized user of the object or an authorized user may be determined by facial recognition in some instances. When the home is unoccupied, the security mode of the second security system may operate in the home mode for the object. For example, if the authorized user has two children (i.e., authorized occupants) who are playing near the locker, the locker may not deactivate the sensors. The second security system may be in the home mode for the object only if certain conditions are met as disclosed herein. Thus, the security system for the gun (e.g., the second security system) may be more sensitive to a disturbance when the home security system is in the home mode than when the home security system is in the away mode.

Continuing the above example, the locker for the gun may contain a conventional electronic combination lock that can be used to deactivate the second security system as well. In the event the controller and/or remote system receives the correct combination, for example, it may deactivate the sensors on the locker and/or the gun for a configurable period of time. Thus, a user can override the second security system's default programming.

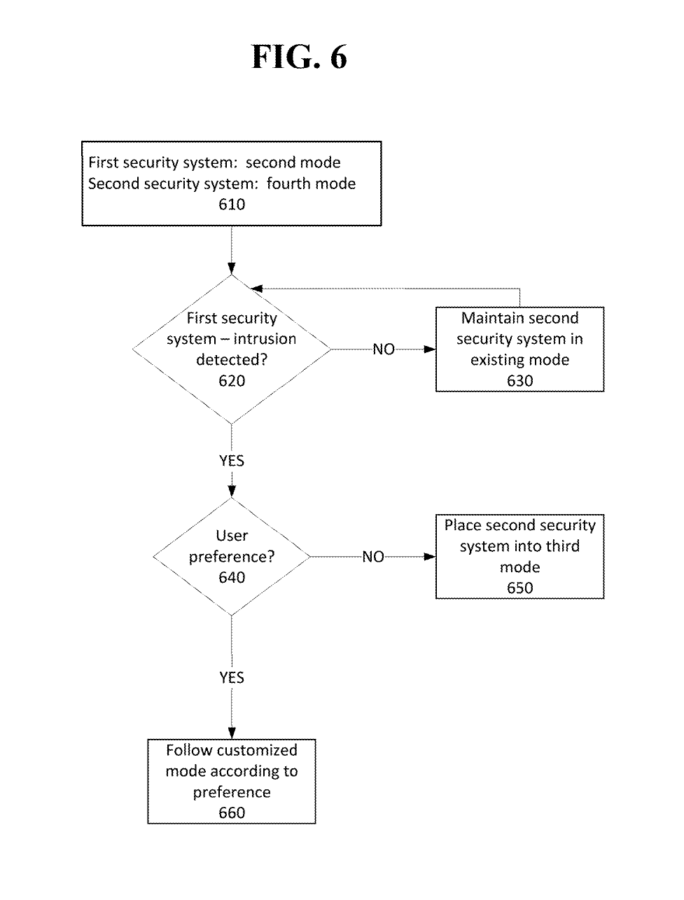

FIG. 6 is an example configuration of the first security system (e.g., for a home premises) and the second security system (e.g., for an object or defined area within the premises) in the event an intrusion or abnormality (e.g., a hazard) is detected by the first security system. At 610, the first security system may be in a second mode of operation (e.g., an away mode) and the second security system may be a fourth mode of operation (e.g., a home mode). Under normal operation, the first security system may determine that no abnormalities and/or intrusions into the house presently exist at 620. It may maintain the second security system in its existing mode at 630. If, however, the first security system detects an intrusion at 620, it may determine if there is a user preference 640. If no preference is specified (or the system does not contain a user preference), then the system may place the second security system into a third mode of operation (e.g., an away mode) at 650. If a user preference is present, the system may adjust the operation of the sensors associated with second security system according to the preference specified at 660. For example, under a default operation at 650, the sensors may be configured to emit a beep or flash an LED upon movement of the object. A customized program at 660 may dispatch a notice to an authorized occupant or user, a third party (e.g., law enforcement or the like), etc.

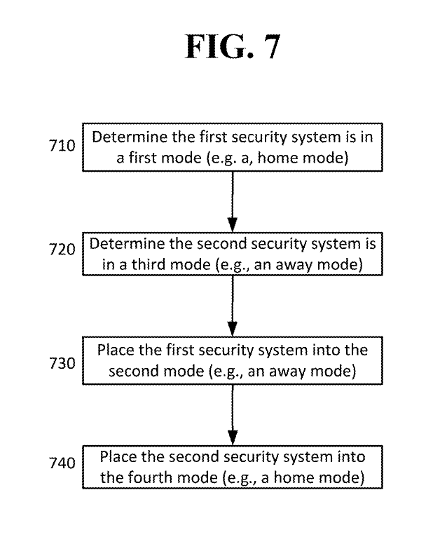

FIG. 7 is an example process for transitioning the second security system from a third mode to a fourth mode in the event a first security system is transitioned from a first mode to a second mode of operation. At 710, a processor of the first security system, for example, may determine that the first security system is in a first mode. The processor may be associated with a controller and/or remote system as described herein. The processor may be part of the second security system in some configurations (e.g., it may receive an indication of the first security system's mode).

The first mode (e.g., a home mode) may define a first response to an event and a second mode (e.g., an away mode) may define a second response to the event. An event may refer to an intrusion into the home, an abnormality such as a fire hazard or smoke hazard, and/or a learned behavior. A learned behavior may refer to patterns of occupancy and device usage (e.g., lights, HVAC, outlets, etc.) that can be inferred based on observing the behavior over a period of time when the home is occupied. A learned behavior, for example, may indicate a pattern of when and where lights are turned on in the home. The behavior may be modified based on new input data. For example, the system may activate or deactivate lights based on a learned pattern. If a user provides an instruction that is contrary to the learned behavior, it may be received by the controller as new input. The learned pattern may be modified if enough new input is received to indicate that it is an actual pattern instead of a random or infrequent event.

As a specific example, an intrusion (e.g., a window being opened) may be detected while the first security system is in the away mode. This may cause the system to generate a notice to law enforcement immediately and/or to the user. If the security system is in the home mode, however, and it detects a movement of the window, the system may not generate a notice. Thus, the response to the event (a window opening) is different depending on the mode in which the system is operating.

A second security system may be determined to be in the third mode (e.g., away mode) at 720. The second security system, as described above, may be within the premises of the first security system as described above. The controller and/or remote system may receive an indication of the second security system's status. For example, a sensor package affixed to an object may transmit its activity to the controller. Similarly, the controller may provide instructions to the sensor package.

The first security system may be placed into a second mode (e.g., an away mode) based on an indication received by the processor of the controller at 730. The indication to automatically transition the home security system from a home mode to an away mode may be based on occupancy detection. For example, a client device of a user (e.g., a smart watch, a smartphone, etc.) may communicate GPS signals to the controller with the user's permissions. When the user crosses a geofence near the home, the system may automatically transition the house. As another example, motion sensors on the interior of the home may detect movement towards an entry door. The entry door may be determined to be opened and then closed based on an accelerometer and magnetometer affixed to the door and/or door enclosure. A motion sensor on the exterior of the home may detect movement. The interior motion sensors of the home may not detect any further motion. This may be inferred by the system to indicate that the home is unoccupied. It may initiate a timer that can count down or up depending on the configuration. Upon expiration of the timer or crossing a threshold, respectively, the home security system may transition to an away mode. Responsive to the first security system being placed into the away mode, the second security system may be placed into the fourth mode (e.g., a home mode) at 740.

The following non-limiting examples represent specific use cases for the disclosed implementations herein. In general, the sensors utilized by the second security system (e.g., those associated with a specific object within a home) may operate independent of the home's security system. However, the sensors associated with the object may leverage the controller and/or remote system of the home's security system (e.g., the sensors and/or data generated therefrom). For example, despite the home security system being placed in a home mode, the object's sensors may remain activated and prepared to alarm or alert an authorized user of the object.

The sensors associated with the second security system may be placed on a moveable object such that if an individual picks up or moves the object, the sensors may cause an alarm to be emitted. The resultant behavior in the event of a particular event detected by a sensor may be configured by an authorized user (e.g., one who associates the sensor with the object). For example, a chime may be emitted, a notification may be generated, the notice may be sent to a variety of parties or electronic devices, etc. As another example, two drawers of a file cabinet may not be allowed to be simultaneously opened without an alarm being raised by the second security system. In these specific examples, the home security system may be in a home mode while the second security system may be in an away mode for the object or protected area. Disturbance of the object while the second security system is in the away mode may result in increasingly harsher warnings (e.g., increasingly louder and/or more frequent sounds).

As another specific example, a baby gate in a home may be an object that is part of a second security system. The home security system may be in a home mode and the second security system (e.g., the gate) may be in an away mode. In the event the door to the baby gate is open, it may emit a chime. When the door is closed, no sound may be emitted. Similarly, if the house in which the gate is located is placed into an away mode, the gate's sensors may be placed into a silent mode of operation. That is, even if the gate's door is open, no chime may be emitted because there is nobody at home to receive or respond to the chime.

A variety of sensors may be employed by the first security system and/or the second security system. A non-limiting list includes an accelerometer, a compass, a humidity sensor, a temperature sensors, a light sensor, air sensor (e.g., a carbon monoxide detector, a methane detector, or other volatile organic compound detectors), a motion sensor (e.g. passive infrared (“PIR”)), a camera, a microphone, a magnetometer, pressure sensor, etc. For example, an ambient light sensor may be placed inside a cabinet. When the door to the cabinet is closed, the light sensor will register low light. If the door is opened, the light sensor will detect a relatively large increase in light and the second security system may infer that the cabinet door has been opened. A temperature and/or humidity sensor may be utilized to observe a painting or a wine cellar. For example, they may be components of a sensor package that are can be situated in the wine cellar or on specific bottles in the wine cellar. In some configurations, a camera may have a temperature and/or humidity detection capability.

In some configurations, the data generated by the first security system and/or the second security system may augment one another. For example, the sensors disclosed herein generally may communicate utilizing a radio signal. The radio signal for an object may indicate that the object is communicating with the controller and suddenly drops off the network (e.g., is not detected by the controller and/or data generated by the sensor are no longer being received by the controller). For example, the object may have an accelerometer affixed to it. The accelerometer may detect movement and suddenly cease movement or stop outputting accelerometer data. Subsequent to the fall-off of the sensor, an exterior door may open. This may be detected as an abnormality by the home security system and/or the object's sensors. An alarm and/or notice may be generated and/or dispatched in response thereto.

The sensors may operate in manner that differs from its standard mode of operation when the home is in a particular configuration. For example, a second security system may include a child's room and the lights connected thereto. The lights in the child's room may be configured to turn off at a particular time. The lights of that particular room may behave independent of the home security system's mode of operation. In the event the lights in the child's room are turned on during a time they are configured to be off, a notice may be dispatched to a parent's client device (e.g., a smartphone).

As described above, abnormal behavior with respect to the homes security system or smart home environment may be detected. For example, an occupant may have a valuable object such as a violin that may have a sensor attached to it. Similarly, a painting's frame or enclosure may have a temperature/humidity sensor attached to it. In the event the object is dropped, a notice may be dispatched to a client device. There may be threshold level of activation for any particular sensor. For example, a painting may be gently moved as part of a routine cleaning This may not be sufficient to trigger a response from the second system's sensors and/or the controller and/or remote system of the first system. However, if the painting drops off of the wall, then the threshold level of movement may have been reached for a notice to be generated and sent to a client device (e.g., smartphone, tablet, and computer).

As another example, a key ring may have a sensor in it and be attached to an object. The key ring may include a noise generator in it. When the object to which the key ring is attached moves in an abnormal manner, it may begin to emit a sound. An abnormal movement may be predetermined (e.g., a specific amount of acceleration) and/or a specified distance of movement. As another example, if a person picks up an object to which a sensor of a second system is attached, the second system may inform the person moving the object that it is not to be touched or moved. In the event that the movement continues, the second system may escalate the warning. For example, it may emit a beep and flash an LED for a brief period of time and repeat the warning. If the movement continues, it may increase the volume of the beeps and their duration, flash the LED for a longer period of time and at a bright intensity (e.g. more LEDs illuminate), and dispatch a notice to an authorized user.

As another example, some safes and/or gun lockers may, by virtue of their construction, may act as a Faraday cage, thereby preventing radio signals from being transmitted to a controller and/or remote system. In such instances, the sensor attached to the gun inside the locker may not be detectable by the controller (e.g., outside of the safe). However, if the door to the safe is opened, the sensor may be detected. In this case, the sensor suddenly appearing may cause a behavior change by the second security system. For example, if an accelerometer attached to a gun suddenly appears on the network, the system may determine an authorized user is near the gun's safe and/or if there is an authorized occupant in the house. In this case, it may not take any additional action. If, however, an authorized user is not near the gun's safe, then the system may emit a warning as described above. If the gun is returned to the safe (e.g., the accelerometer no longer is transmitting data), the system may return to its previous mode of operation unless other abnormal behavior is detected.

A dog collar may have a sensor associated with it representing a second security system. In the event the dog collar leaves the perimeter of the first security system (e.g., the home), then a notice may be dispatched to the owner. A similar configuration may be applied to children.

A second security system may be associated with a briefcase or other object that an authorized user frequently takes to work (e.g., a phone or wallet). In the event that the user leaves the home without the object, the second security system may trigger a beep and/or otherwise alert the authorized user to the forgotten object.

A sensor may be associated with a mailbox to determine whether mail has been delivered. The sensor may be a door open/close sensor or one that determines whether anything has passed through a slot in the mailbox.

An air sensor may be utilized to alert a user that the garbage needs to be removed from the interior of the home.

Implementations disclosed herein may use one or more sensors. In general, a “sensor” may refer to any device that can obtain information about its environment. Sensors may be described in terms of the type of information they collect. For example, sensor types as disclosed herein may include motion, smoke, carbon monoxide, proximity, temperature, time, physical orientation, acceleration, location, entry, presence, pressure, light, sound, and the like. A sensor also may be described in terms of the particular physical device that obtains the environmental information. For example, an accelerometer may obtain acceleration information, and thus may be used as a general motion sensor and/or an acceleration sensor. A sensor also may be described in terms of the specific hardware components used to implement the sensor. For example, a temperature sensor may include a thermistor, thermocouple, resistance temperature detector, integrated circuit temperature detector, or combinations thereof. A sensor also may be described in terms of a function or functions the sensor performs within an integrated sensor network, such as a smart home environment as disclosed herein. For example, a sensor may operate as a security sensor when it is used to determine security events such as unauthorized entry. A sensor may operate with different functions at different times, such as where a motion sensor is used to control lighting in a smart home environment when an authorized user is present, and is used to alert to unauthorized or unexpected movement when no authorized user is present, or when an alarm system is in an away (e.g., “armed”) state, or the like. In some cases, a sensor may operate as multiple sensor types sequentially or concurrently, such as where a temperature sensor is used to detect a change in temperature, as well as the presence of a person or animal. A sensor also may operate in different modes at the same or different times. For example, a sensor may be configured to operate in one mode during the day and another mode at night. As another example, a sensor may operate in different modes based upon a state of a home security system or a smart home environment, or as otherwise directed by such a system.

In general, a “sensor” as disclosed herein may include multiple sensors or sub-sensors, such as where a position sensor includes both a global positioning sensor (GPS) as well as a wireless network sensor, which provides data that can be correlated with known wireless networks to obtain location information. Multiple sensors may be arranged in a single physical housing, such as where a single device includes movement, temperature, magnetic, and/or other sensors. Such a housing also may be referred to as a sensor, a sensor device, or a sensor package. For clarity, sensors are described with respect to the particular functions they perform and/or the particular physical hardware used, when such specification is necessary for understanding of the implementations disclosed herein.

A sensor may include hardware in addition to the specific physical sensor that obtains information about the environment. FIG. 8A shows an example sensor as disclosed herein. The sensor 60 may include an environmental sensor 61, such as a temperature sensor, smoke sensor, carbon monoxide sensor, motion sensor, accelerometer, proximity sensor, passive infrared (PIR) sensor, magnetic field sensor, radio frequency (RF) sensor, light sensor, humidity sensor, pressure sensor, microphone, or any other suitable environmental sensor, that obtains a corresponding type of information about the environment in which the sensor 60 is located. A processor 64 may receive and analyze data obtained by the sensor 61, control operation of other components of the sensor 60, and process communication between the sensor and other devices. The processor 64 may execute instructions stored on a computer-readable memory 65. The memory 65 or another memory in the sensor 60 may also store environmental data obtained by the sensor 61. A communication interface 63, such as a Wi-Fi or other wireless interface, Ethernet or other local network interface, or the like may allow for communication by the sensor 60 with other devices. A user interface (UI) 62 may provide information and/or receive input from a user of the sensor. The UI 62 may include, for example, a speaker to output an audible alarm when an event is detected by the sensor 60. Alternatively, or in addition, the UI 62 may include a light to be activated when an event is detected by the sensor 60. The user interface may be relatively minimal, such as a liquid crystal display (LCD), light-emitting diode (LED) display, or limited-output display, or it may be a full-featured interface such as a touchscreen.

Components within the sensor 60 may transmit and receive information to and from one another via an internal bus or other mechanism as will be readily understood by one of skill in the art. One or more components may be implemented in a single physical arrangement, such as where multiple components are implemented on a single integrated circuit. Sensors as disclosed herein may include other components, and/or may not include all of the illustrative components shown.

In some configurations, two or more sensors may generate data that can be used by a processor of a system to generate a response and/or infer a state of the environment. For example, an ambient light sensor in a room may determine that the room is dark (e.g., less than 60 lux). A microphone in the room may detect a sound above a set threshold, such as 60 dB. The system processor may determine, based on the data generated by both sensors that it should activate one or more lights in the room. In the event the processor only received data from the ambient light sensor, the system may not have any basis to alter the state of the lighting in the room. Similarly, if the processor only received data from the microphone, the system may lack sufficient data to determine whether activating the lights in the room is necessary, for example, during the day the room may already be bright or during the night the lights may already be on. As another example, two or more sensors may communicate with one another. Thus, data generated by multiple sensors simultaneously or nearly simultaneously may be used to determine a state of an environment and, based on the determined state, generate a response.

As another example, a security system may employ a magnetometer affixed to a doorjamb and a magnet affixed to the door. When the door is closed, the magnetometer may detect the magnetic field emanating from the magnet. If the door is opened, the increased distance may cause the magnetic field near the magnetometer to be too weak to be detected by the magnetometer. If the security system is activated, it may interpret such non-detection as the door being ajar or open. In some configurations, a separate sensor or a sensor integrated into one or more of the magnetometer and/or magnet may be incorporated to provide data regarding the status of the door. For example, an accelerometer and/or a compass may be affixed to the door and indicate the status of the door and/or augment the data provided by the magnetometer. FIG. 9A shows a schematic representation of an example of a door that opens by a hinge mechanism 91. In the first position 92, the door is closed and the compass 98 may indicate a first direction. The door may be opened at a variety of positions as shown 93, 94, 95. The fourth position 95 may represent the maximum amount the door can be opened. Based on the compass 98 readings, the position of the door may be determined and/or distinguished more specifically than merely open or closed. In the second position 93, for example, the door may not be far enough apart for a person to enter the home. A compass or similar sensor may be used in conjunction with a magnet, such as to more precisely determine a distance from the magnet, or it may be used alone and provide environmental information based on the ambient magnetic field, as with a conventional compass.

FIG. 9B shows a compass 98 in two different positions, 92, 94, from FIG. 9A. In the first position 92, the compass detects a first direction 96. The compass's direction is indicated as 97 and it may be a known distance from a particular location. For example, when affixed to a door, the compass may automatically determine the distance from the doorjamb or a user may input a distance from the doorjamb. The distance representing how far away from the doorjamb the door is 99 may be computed by a variety of trigonometric formulas. In the first position 92, the door is indicated as not being separate from the doorjamb (i.e., closed) 99. Although features 96 and 97 are shown as distinct in FIG. 9B, they may overlap entirely. In the second position 94, the distance between the doorjamb and the door 99 may indicate that the door has been opened wide enough that a person may enter. Thus, the sensors may be integrated into a home security system, mesh network (e.g., Thread), or work in combination with other sensors positioned in and/or around an environment.

In some configurations, an accelerometer may be employed to indicate how quickly the door is moving. For example, the door may be lightly moving due to a breeze. This may be contrasted with a rapid movement due to a person swinging the door open. The data generated by the compass, accelerometer, and/or magnetometer may be analyzed and/or provided to a central system such as a controller 73 and/or remote system 74 as previously described. The data may be analyzed to learn a user behavior, an environment state, and/or as a component of a home security or home automation system. While the above example is described in the context of a door, a person having ordinary skill in the art will appreciate the applicability of the disclosed subject matter to other implementations such as a window, garage door, fireplace doors, vehicle windows/doors, faucet positions (e.g., an outdoor spigot), a gate, seating position, etc.

Data generated by one or more sensors may indicate a behavior pattern of one or more users and/or an environment state over time, and thus may be used to “learn” such characteristics. For example, data generated by an ambient light sensor in a room of a house and the time of day may be stored in a local or remote storage medium with the permission of an end user. A processor in communication with the storage medium may compute a behavior based on the data generated by the light sensor. The light sensor data may indicate that the amount of light detected increases until an approximate time or time period, such as 3:30 PM, and then declines until another approximate time or time period, such as 5:30 PM, at which point there an abrupt increase in the amount of light is detected. In many cases, the amount of light detected after the second time period may be either below a dark level of light (e.g., under or equal to 60 lux) or bright (e.g., equal to or above 400 lux). In this example, the data may indicate that after 5:30 PM, an occupant is turning on/off a light as the occupant of the room in which the sensor is located enters/leaves the room. At other times, the light sensor data may indicate that no lights are turned on/off in the room. The system, therefore, may learn that occupants patterns of turning on and off lights, and may generate a response to the learned behavior. For example, at 5:30 PM, a smart home environment or other sensor network may automatically activate the lights in the room if it detects an occupant in proximity to the home. In some implementations, such behavior patterns may be verified using other sensors. Continuing the example, user behavior regarding specific lights may be verified and/or further refined based upon states of, or data gathered by, smart switches, outlets, lamps, and the like.

Sensors as disclosed herein may operate within a communication network, such as a conventional wireless network, and/or a sensor-specific network through which sensors may communicate with one another and/or with dedicated other devices. In some configurations, one or more sensors may provide information to one or more other sensors, to a central controller, or to any other device capable of communicating on a network with the one or more sensors. A central controller may be general- or special-purpose. For example, one type of central controller is a home automation network that collects and analyzes data from one or more sensors within the home. Another example of a central controller is a special-purpose controller that is dedicated to a subset of functions, such as a security controller that collects and analyzes sensor data primarily or exclusively as it relates to various security considerations for a location. A central controller may be located locally with respect to the sensors with which it communicates and from which it obtains sensor data, such as in the case where it is positioned within a home that includes a home automation and/or sensor network. Alternatively or in addition, a central controller as disclosed herein may be remote from the sensors, such as where the central controller is implemented as a cloud-based system that communicates with multiple sensors, which may be located at multiple locations and may be local or remote with respect to one another.

FIG. 8B shows an example of a sensor network as disclosed herein, which may be implemented over any suitable wired and/or wireless communication networks. One or more sensors 71, 72 may communicate via a local network 70, such as a Wi-Fi or other suitable network, with each other and/or with a controller 73. The controller may be a general- or special-purpose computer such as a smartphone, a smartwatch, a tablet, a laptop, etc. The controller may, for example, receive, aggregate, and/or analyze environmental information received from the sensors 71, 72. The sensors 71, 72 and the controller 73 may be located locally to one another, such as within a single dwelling, office space, building, room, or the like, or they may be remote from each other, such as where the controller 73 is implemented in a remote system 74 such as a cloud-based reporting and/or analysis system. In some configurations, the system may have multiple controllers 74 such as where multiple occupants' smartphones and/or smartwatches are authorized to control and/or send/receive data to or from the various sensors 71, 72 deployed in the home. Alternatively or in addition, sensors may communicate directly with a remote system 74. The remote system 74 may, for example, aggregate data from multiple locations, provide instruction, software updates, and/or aggregated data to a controller 73 and/or sensors 71, 72.

The devices of the security system and smart-home environment of the disclosed subject matter may be communicatively connected via the network 70, which may be a mesh-type network such as Thread, which provides network architecture and/or protocols for devices to communicate with one another. Typical home networks may have a single device point of communications. Such networks may be prone to failure, such that devices of the network cannot communicate with one another when the single device point does not operate normally. The mesh-type network of Thread, which may be used in the security system of the disclosed subject matter, may avoid communication using a single device. That is, in the mesh-type network, such as network 70, there is no single point of communication that may fail and prohibit devices coupled to the network from communicating with one another.

The communication and network protocols used by the devices communicatively coupled to the network 70 may provide secure communications, minimize the amount of power used (i.e., be power efficient), and support a wide variety of devices and/or products in a home, such as appliances, access control, climate control, energy management, lighting, safety, and security. For example, the protocols supported by the network and the devices connected thereto may have an open protocol which may carry IPv6 natively.

The Thread network, such as network 70, may be easy to set up and secure to use. The network 70 may use an authentication scheme, AES (Advanced Encryption Standard) encryption, or the like to reduce and/or minimize security holes that exist in other wireless protocols. The Thread network may be scalable to connect devices (e.g., 2, 5, 10, 20, 50, 100, 150, 200, or more devices) into a single network supporting multiple hops (e.g., to provide communications between devices when one or more nodes of the network is not operating normally). The network 70, which may be a Thread network, may provide security at the network and application layers. One or more devices communicatively coupled to the network 70 (e.g., controller 73, remote system 74, and the like) may store product install codes to ensure only authorized devices can join the network 70. One or more operations and communications of network 70 may use cryptography, such as public-key cryptography.

The devices communicatively coupled to the network 70 of the smart-home environment and/or security system disclosed herein may low power consumption and/or reduced power consumption. That is, devices efficiently communicate to with one another and operate to provide functionality to the user, where the devices may have reduced battery size and increased battery lifetimes over conventional devices. The devices may include sleep modes to increase battery life and reduce power requirements. For example, communications between devices coupled to the network 70 may use the power-efficient IEEE 802.15.4 MAC/PHY protocol. In embodiments of the disclosed subject matter, short messaging between devices on the network 70 may conserve bandwidth and power. The routing protocol of the network 70 may reduce network overhead and latency. The communication interfaces of the devices coupled to the smart-home environment may include wireless system-on-chips to support the low-power, secure, stable, and/or scalable communications network 70.

The sensor network shown in FIG. 8B may be an example of a smart-home environment. The depicted smart-home environment may include a structure, a house, office building, garage, mobile home, or the like. The devices of the smart home environment, such as the sensors 71, 72, the controller 73, and the network 70 may be integrated into a smart-home environment that does not include an entire structure, such as an apartment, condominium, or office space.

The smart home environment can control and/or be coupled to devices outside of the structure. For example, one or more of the sensors 71, 72 may be located outside the structure, for example, at one or more distances from the structure (e.g., sensors 71, 72 may be disposed outside the structure, at points along a land perimeter on which the structure is located, and the like. One or more of the devices in the smart home environment need not physically be within the structure. For example, the controller 73 which may receive input from the sensors 71, 72 may be located outside of the structure.

The structure of the smart-home environment may include a plurality of rooms, separated at least partly from each other via walls. The walls can include interior walls or exterior walls. Each room can further include a floor and a ceiling. Devices of the smart-home environment, such as the sensors 71, 72, may be mounted on, integrated with and/or supported by a wall, floor, or ceiling of the structure.

The smart-home environment including the sensor network shown in FIG. 8B may include a plurality of devices, including intelligent, multi-sensing, network-connected devices, that can integrate seamlessly with each other and/or with a central server or a cloud-computing system (e.g., controller 73 and/or remote system 74) to provide home-security and smart-home features. The smart-home environment may include one or more intelligent, multi-sensing, network-connected thermostats (e.g., “smart thermostats”), one or more intelligent, network-connected, multi-sensing hazard detection units (e.g., “smart hazard detectors”), and one or more intelligent, multi-sensing, network-connected entryway interface devices (e.g., “smart doorbells”). The smart hazard detectors, smart thermostats, and smart doorbells may be the sensors 71, 72 shown in FIG. 8B.

For example, a smart thermostat may detect ambient climate characteristics (e.g., temperature and/or humidity) and may control an HVAC (heating, ventilating, and air conditioning) system accordingly of the structure. For example, the ambient client characteristics may be detected by sensors 71, 72 shown in FIG. 8B, and the controller 73 may control the HVAC system (not shown) of the structure.

As another example, a smart hazard detector may detect the presence of a hazardous substance or a substance indicative of a hazardous substance (e.g., smoke, fire, or carbon monoxide). For example, smoke, fire, and/or carbon monoxide may be detected by sensors 71, 72 shown in FIG. 8B, and the controller 73 may control an alarm system to provide a visual and/or audible alarm to the user of the smart-home environment.

As another example, a smart doorbell may control doorbell functionality, detect a person's approach to or departure from a location (e.g., an outer door to the structure), and announce a person's approach or departure from the structure via audible and/or visual message that is output by a speaker and/or a display coupled to, for example, the controller 73.

In some embodiments, the smart-home environment of the sensor network shown in FIG. 8B may include one or more intelligent, multi-sensing, network-connected wall switches (e.g., “smart wall switches”), one or more intelligent, multi-sensing, network-connected wall plug interfaces (e.g., “smart wall plugs”). The smart wall switches and/or smart wall plugs may be or include one or more of the sensors 71, 72 shown in FIG. 8B. A smart wall switch may detect ambient lighting conditions, and control a power and/or dim state of one or more lights. For example, a sensor such as sensors 71, 72, may detect ambient lighting conditions, and a device such as the controller 73 may control the power to one or more lights (not shown) in the smart-home environment. Smart wall switches may also control a power state or speed of a fan, such as a ceiling fan. For example, sensors 72, 72 may detect the power and/or speed of a fan, and the controller 73 may adjust the power and/or speed of the fan, accordingly. Smart wall plugs may control supply of power to one or more wall plugs (e.g., such that power is not supplied to the plug if nobody is detected to be within the smart-home environment). For example, one of the smart wall plugs may control supply of power to a lamp (not shown).

In implementations of the disclosed subject matter, a smart-home environment may include one or more intelligent, multi-sensing, network-connected entry detectors (e.g., “smart entry detectors”). Such detectors may be or include one or more of the sensors 71, 72 shown in FIG. 8B. The illustrated smart entry detectors (e.g., sensors 71, 72) may be disposed at one or more windows, doors, and other entry points of the smart-home environment for detecting when a window, door, or other entry point is opened, broken, breached, and/or compromised. The smart entry detectors may generate a corresponding signal to be provided to the controller 73 and/or the remote system 74 when a window or door is opened, closed, breached, and/or compromised. In some implementations of the disclosed subject matter, the alarm system, which may be included with controller 73 and/or coupled to the network 70 may not be placed in an away mode (e.g., “armed”) unless all smart entry detectors (e.g., sensors 71, 72) indicate that all doors, windows, entryways, and the like are closed and/or that all smart entry detectors are in an away mode. In some configurations, such as the door example shown in FIGS. 9A and 9B, the system may arm if it can be determined that the distance the door (or window) is ajar is insubstantial (e.g., the opening is not wide enough for a person to fit through).

The smart-home environment of the sensor network shown in FIG. 8B can include one or more intelligent, multi-sensing, network-connected doorknobs (e.g., “smart doorknob”). For example, the sensors 71, 72 may be coupled to a doorknob of a door (e.g., doorknobs 122 located on external doors of the structure of the smart-home environment). However, it should be appreciated that smart doorknobs can be provided on external and/or internal doors of the smart-home environment.

The smart thermostats, the smart hazard detectors, the smart doorbells, the smart wall switches, the smart wall plugs, the smart entry detectors, the smart doorknobs, the keypads, and other devices of a smart-home environment (e.g., as illustrated as sensors 71, 72 of FIG. 8B) can be communicatively coupled to each other via the network 70, and to the controller 73 and/or remote system 74 to provide security, safety, and/or comfort for the smart home environment.

A user can interact with one or more of the network-connected smart devices (e.g., via the network 70). For example, a user can communicate with one or more of the network-connected smart devices using a computer (e.g., a desktop computer, laptop computer, tablet, or the like) or other portable electronic device (e.g., a smartphone, a tablet, a key FOB, or the like). A webpage or application can be configured to receive communications from the user and control the one or more of the network-connected smart devices based on the communications and/or to present information about the device's operation to the user. For example, the user can view, arm or disarm the security system of the home.

One or more users can control one or more of the network-connected smart devices in the smart-home environment using a network-connected computer or portable electronic device. In some examples, some or all of the users (e.g., individuals who live in the home) can register their mobile device and/or key FOBs with the smart-home environment (e.g., with the controller 73). Such registration can be made at a central server (e.g., the controller 73 and/or the remote system 74) to authenticate the user and/or the electronic device as being associated with the smart-home environment, and to provide permission to the user to use the electronic device to control the network-connected smart devices and the security system of the smart-home environment. A user can use their registered electronic device to remotely control the network-connected smart devices and security system of the smart-home environment, such as when the occupant is at work or on vacation. The user may also use their registered electronic device to control the network-connected smart devices when the user is located inside the smart-home environment.

Alternatively, or in addition to registering electronic devices, the smart-home environment may make inferences about which individuals live in the home and are therefore users and which electronic devices are associated with those individuals. As such, the smart-home environment may “learn” who is a user (e.g., an authorized user) and permit the electronic devices associated with those individuals to control the network-connected smart devices of the smart-home environment (e.g., devices communicatively coupled to the network 70), in some embodiments including sensors used by or within the smart-home environment. Various types of notices and other information may be provided to users via messages sent to one or more user electronic devices. For example, the messages can be sent via email, short message service (SMS), multimedia messaging service (MMS), unstructured supplementary service data (USSD), as well as any other type of messaging services and/or communication protocols.

A smart-home environment may include communication with devices outside of the smart-home environment but within a proximate geographical range of the home. For example, the smart-home environment may include an outdoor lighting system (not shown) that communicates information through the communication network 70 or directly to a central server or cloud-computing system (e.g., controller 73 and/or remote system 74) regarding detected movement and/or presence of people, animals, and any other objects and receives back commands for controlling the lighting accordingly.

The controller 73 and/or remote system 74 can control the outdoor lighting system based on information received from the other network-connected smart devices in the smart-home environment. For example, in the event that any of the network-connected smart devices, such as smart wall plugs located outdoors, detect movement at nighttime, the controller 73 and/or remote system 74 can activate the outdoor lighting system and/or other lights in the smart-home environment.

In some configurations, a remote system 74 may aggregate data from multiple locations, such as multiple buildings, multi-resident buildings, and individual residences within a neighborhood, multiple neighborhoods, and the like. In general, multiple sensor/controller systems 81, 82 as previously described with respect to FIG. 8B may provide information to the remote system 74 as shown in FIG. 8C. The systems 81, 82 may provide data directly from one or more sensors as previously described, or the data may be aggregated and/or analyzed by local controllers such as the controller 73, which then communicates with the remote system 74. The remote system may aggregate and analyze the data from multiple locations, and may provide aggregate results to each location. For example, the remote system 74 may examine larger regions for common sensor data or trends in sensor data, and provide information on the identified commonality or environmental data trends to each local system 81, 82.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. As another example, systems disclosed herein may allow a user to restrict the information collected by the systems disclosed herein to applications specific to the user, such as by disabling or limiting the extent to which such information is aggregated or used in analysis with other information from other users. Thus, the user may have control over how information is collected about the user and used by a system as disclosed herein.

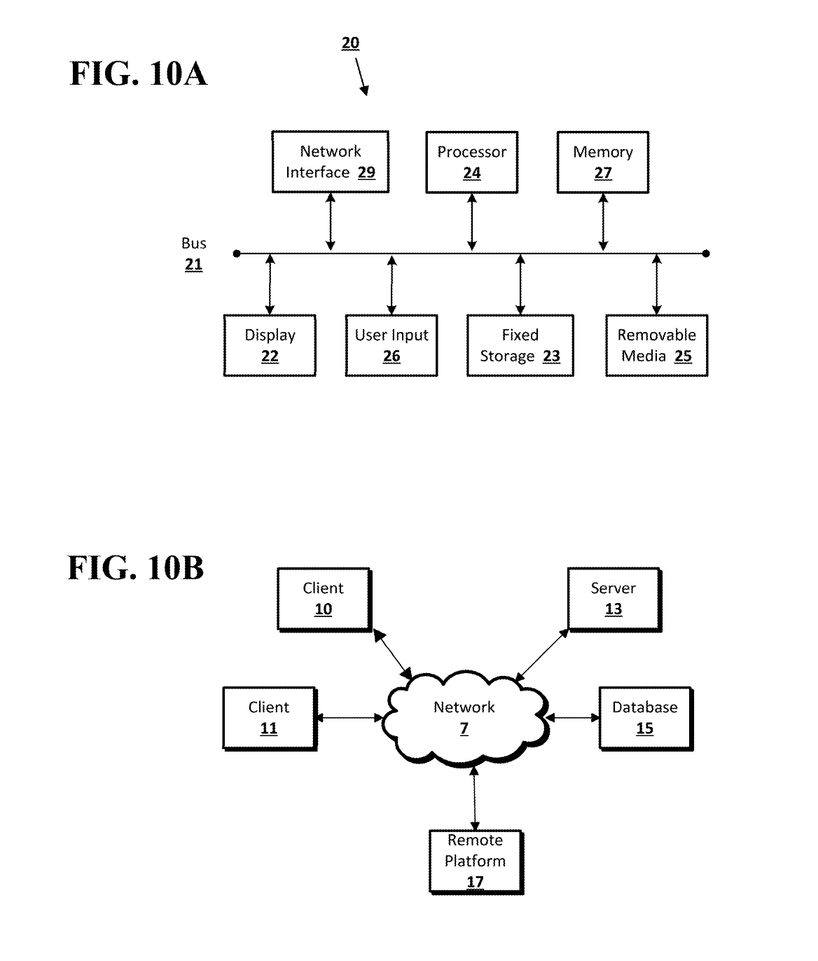

Implementations of the presently disclosed subject matter may be implemented in and used with a variety of component and network architectures. FIG. 10A is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) that controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an Internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection, or the like. For example, the network interface 29 may allow the computer to communicate with other computers via one or more local, wide-area, or other networks, as shown in FIG. 10B.

Many other devices or components (not shown) may be connected in a similar manner (e.g., document scanners, digital cameras, and so on). Conversely, all of the components shown in FIG. 10A need not be present to practice the present disclosure. The components can be interconnected in different ways from that shown. The operation of a computer such as that shown in FIG. 10A is readily known in the art and is not discussed in detail in this application. Code to implement the present disclosure can be stored in computer-readable storage media such as one or more of the memory 27, fixed storage 23, removable media 25, or on a remote storage location.

FIG. 10B shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. The disclosed subject matter also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions.

Implementations may use hardware that includes a processor, such as a general-purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A system, comprising:
a first security system associated with a premises and having a first mode and a second mode, wherein the first mode defines a first response to an event and the second mode defines a second response to the event that differs from the first response; and
a second security system within the premises and having a third mode and a fourth mode, wherein the second security system operates in one of the third mode or the fourth mode based upon a mode in which the first security system is operating.

2. The system of claim 1, wherein the event comprises one of a potential intrusion, a learned behavior, or a potential hazard.

3. The system of claim 1, wherein the first security system comprises a first processor and the second security system comprises a second processor, the first processor configured to detect an intrusion in the security perimeter and the second processor, responsive to the intrusion, transition from the fourth mode to the third mode.

4. The system of claim 3, the first processor further configured to dispatch a notice.

5. The system of claim 1, wherein the first security system corresponds to a home security system of a home and the second security system corresponds to a safe in the home.

6. The system of claim 1, wherein transitioning from the first mode to the second mode is based on a learned behavior for an authorized occupant of the premises.

7. A computer implemented method, comprising:
determining, by a processor, that a first security system associated with a premises is in a first mode, wherein the first mode defines a first response to an event and wherein the first security system has a second mode that defines a second response to the event that differs from the first response;
determining that a second security system, which is within the premises, is in a third mode, wherein the second security system operates in one of the third mode or a fourth mode based at least in part upon a mode in which the first security system is operating;
placing the first security system into the second mode based on an indication received by the processor; and
placing the second security system into the fourth mode based on the first security system being in the second mode.

8. The method of claim 7, wherein the indication comprises an occupancy state for the premises.

9. The method of claim 7, wherein the event comprises one of a potential intrusion, a learned behavior, or a potential hazard.

10. The method of claim 7, further comprising detecting the event.

11. The method of claim 11, further comprising, responsive to the event, dispatching a notice.

12. The method of claim 7, wherein the first security system corresponds to a home security system of a home and the second security system corresponds to a safe in the home.

13. The method of claim 7, wherein transitioning the first security system from a first mode to a second mode is based on a learned behavior for an authorized occupant.
